(19) United States
(12) Patent Application Publication
(10) Pub. No.: US 2015/0037055 A1
(43) Pub. Date: Feb. 5, 2015

(54) IMAGE FORMING APPARATUS

(71) Applicant: CANON KABUSHIKI KAISHA, Tokyo (JP)

(72) Inventors: Oki Kitagawa, Nagareyama-shi (JP); Akiyoshi Shinagawa, Kashiwa-shi (JP); Masanobu Tanaka, Kashiwa-shi (JP)

(21) Appl. No.: 14/520,490

(22) Filed: Oct. 22, 2014

Related U.S. Application Data
(63) Continuation of application No. PCT/JP2013/062864, filed on Apr. 26, 2013.

(30) Foreign Application Priority Data
Apr. 27, 2012 (JP) 2012-103002

(51) Int. Cl. G03G 15/20

(52) U.S. Cl. CPC G03G 15/205
USPC 399/68; 399/69

(57) ABSTRACT

An image forming apparatus includes image forming means for forming an image on a sheet; fixing means for fixing an image formed on a sheet; detecting means for detecting a temperature of the fixing means; and controlling means for controlling an image formation start timing in accordance with an output of the detecting means, wherein in an operation of continuously forming images on a plurality of predetermined sheets, when a number of image formations is not less than a predetermined number, start of the image formation is delayed until a temperature of the fixing means rises up to a first temperature, and when the number of image formations is less than the predetermined number, the image formation is started when the temperature of the fixing means rises up to a second temperature which is lower than the first temperature.

### FIELD OF THE INVENTION

The present invention relates to an image forming apparatus for forming an image on a recording material.

### BACKGROUND ART

In an image forming apparatus for forming an image on a recording material, in order to apply proper heat depending on a kind of the used recording material in a fixing device (image heating device), it is preferable that an applied heat quantity is changed. Therefore, in a device disclosed in Japanese Laid-open Patent Application 2006-78555, when the kind of the recording material changes from plain paper to a thick sheet which has a large thermal capacity, the image forming operation is started after the temperature rise of the fixing device up to a target temperature higher than a target temperature for the plain paper.

In a device disclosed in Japanese Laid-open Patent Application Hei 7-311506, when the kind of the recording material changes from the plain paper to the thick sheet, a process speed (image forming speed, operation speed of the fixing device) is switched to an operation speed which is lower than for the plain paper, and then the image forming operation is started.

However, with the device disclosed in Japanese Laid-open Patent Application 2006-78555, the start of the image formation is delayed until the sufficient temperature rise of the fixing device, irrespective of a number of image formations on the thick sheets, and therefore, a productivity of image formation decreases. For example, in an apparatus capable of processing at a speed of 60 sheets per minute after the temperature rise, if the waiting time for the temperature rise is 30 sec, and only two sheets are processed, the resulting productivity is only four sheets per minute.

In the apparatus disclosed in Japanese Laid-open Patent Application Hei 7-311506, it is liable that the productivity of image formation decreases, because the image formation is started after switching of the process speed to a low speed after completion of the image formation on the plain paper, irrespective of the number of subsequent image formations on the thick sheets. Here, the change of the process speed may require changes of a voltage application condition of image forming means and/or a heating condition of the fixing device, which may results an even longer waiting time. For example, in the case that the image formation is carried out with a productivity of 60 sheets per minute after the switching of the process speed to that for thick sheets, and the condition change requires 30 second, the resultant productivity is only 4 sheets per minute if only two thick sheets are processed.

### SUMMARY OF THE INVENTION

Accordingly, it is a principal object of the present invention to provide an image forming apparatus capable of proper image forming operations with waiting time reduced as much as possible.

According to an aspect of the present invention, there is provided an image forming apparatus comprising image forming means for forming an image on a recording material; fixing means for fixing an image formed on a recording material; detecting means for detecting a temperature of said fixing means; and controlling means for controlling an image formation start timing in accordance with an output of said detecting means, wherein in an operation of continuously forming images on a plurality of predetermined recording materials, when a number of image formations is not less than a predetermined number, start of the image formation is delayed until a temperature of said fixing means rises up to a first temperature, and when the number of image formations is less than the predetermined number, the image formation is started when the temperature of said fixing means rises up to a second temperature which is lower than the first temperature.

According to another aspect of the present invention, there is provided an image forming apparatus comprising image forming means for forming an image on a recording material; fixing means for fixing an image formed on a recording material; detecting means for detecting a temperature of said fixing means; and controlling means for controlling an image formation start timing in accordance with an output of said detecting means, wherein in an operation of continuously forming images on a plurality of predetermined recording materials, when a number of image formations is not less than a predetermined number, start of the image formation is delayed until a temperature of said fixing means rises up to a target temperature predetermined on the basis of a kind of the recording material, and when the number of image formations is less than the predetermined number, the image formation is started when the temperature of said fixing means rises up to a predetermined temperature which is lower than the target temperature.

According to a further aspect of the present invention, there is provided an image forming apparatus comprising image forming means for forming an image on a recording material; fixing means for fixing an image formed on a recording material; and controlling means for controlling an image formation start timing, wherein in an operation of continuously forming images on a plurality of predetermined recording materials, when a number of image formations is not less than a predetermined number, operation speeds of said image forming means and said fixing means are controlled in accordance with a kind of recording material, and when the number of image formations is less than the predetermined number, the operation speeds of said image forming means and said fixing means is controlled at speeds higher than the operation speeds determined in accordance with the kind of the recording material.

According to a further aspect of the present invention, there is provided an image forming apparatus comprising image forming means for forming an image on a recording material; fixing means for fixing an image formed on a recording material; detecting means for detecting a temperature of said fixing means; first controlling means for controlling a target temperature of said fixing means in accordance with a basis weight of recording material; and second controlling means for starting image formation, wherein images are formed continuously on a plurality of recording materials having a first basis weight in a state that a temperature of said fixing means is controlled at a first target temperature predetermined in accordance with the basis weight of the recording material, and then successively, images are formed continuously on a plurality of recording materials having a second basis weight which is larger than the first basis weight, start of image formation is awaited until the temperature of said fixing means rises up to a second target temperature predetermined in accordance with the basis weight of the recording material if the number of image formations is not less than a predetermined number, and the image formation is started when the temperature of said fixing means rises up to a predetermined temperature lower than the second target temperature, when the number of image formations is less than the predetermined number.

According to a further aspect of the present invention, there is provided an image forming apparatus comprising image forming means for forming an image on a recording material; fixing means for heating an image formed on a recording material; first controlling means for controlling operation speeds of said image forming means and said fixing means in accordance with a basis weight of the recording material; and second controlling means for starting image formation, wherein when images are formed continuously on a plurality of recording materials having a first basis weight in a state that operation speeds of said image forming means and said fixing means are a first image forming speed and a first fixing speed, respectively, and then successively, images are formed continuously on a plurality of the recording materials having a second basis weight which is larger than the first basis weight, said second controlling means starts the image formation after decreasing the operation speeds of said image forming means and said fixing means to the second image forming speed and the second fixing speed which are slower than the first image forming speed and the first fixing speed, respectively, if the number of image formations is not less than the predetermined number, and said second controlling means starts the image formation while maintaining the operation speeds of said image forming means and said fixing means at the first image forming speed and the first fixing speed, respectively, if the number of image formations is less than the predetermined number.

Other objects of the present invention will become apparent when the following detailed description is read in conjunction with the accompanying drawings.

### BRIEF DESCRIPTION OF THE DRAWINGS

FIG. 1 is an illustration of a structure of an image forming apparatus.

FIG. 2 is a block diagram of a control system of the image forming apparatus.

FIG. 3 is an illustration of a structure of a fixing device in a cross-sectional view.

FIG. 4 is a flow chart of a control according to Embodiment 1.

FIG. 5 is an illustration of a temperature change of a fixing roller at the time when a process on the thick sheet is started from a stand-by state.

FIG. 6 is a flow chart of a control according to Embodiment 2.

FIG. 7 is an illustration of a temperature change of a fixing roller at the time when the recording material changes from the thin sheet to the thick sheet.

### DESCRIPTION OF THE EMBODIMENTS

Embodiments of the present invention will be described in detail referring to the accompanying drawings. The embodiments may be modified by replacing a part of entirety of the structures of the following embodiments with a substitute within a concept of the present invention.

### <Image Forming Apparatus>

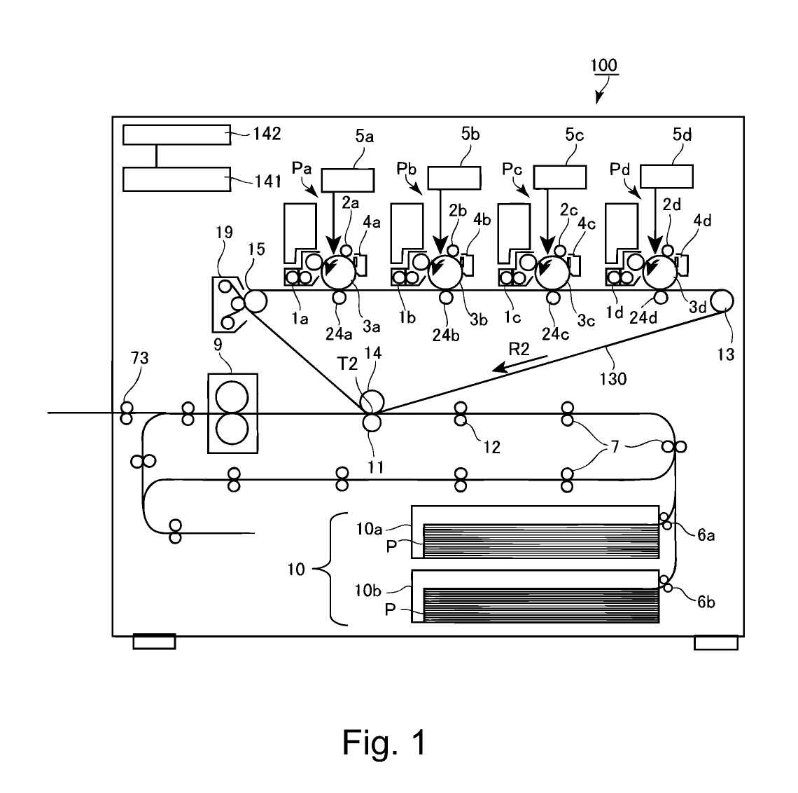

FIG. 1 is an illustration of a structure of an image forming apparatus. As shown in FIG. 1, an image forming apparatus 100 comprises an image forming portion functioning as image forming means for forming an image on a recording material, and a fixing device functioning as fixing means for fixing an image formed on a recording material. More specifically, in this example, the image forming portion includes four image forming stations, a mechanism for transferring images formed by the image forming stations, that is, an intermediary transfer member, a recording material cassette accommodating the recording materials, a feeding mechanism for feeding the recording material to a secondary transfer portion, and so on,

The image forming apparatus in this embodiment is a full color printer of a tandem type and an intermediary transfer type in which the yellow, magenta, cyan and black image forming stations Pa, Pb, Pc and Pd are arranged along an intermediary transfer belt 130 as the intermediary transfer member.

In an image forming station Pa, a yellow toner image is formed on a photosensitive drum 3a, and is transferred onto the intermediary transfer belt 130. In an image forming station Pb, a magenta toner image is formed on the photosensitive drum 3b, and is transferred onto the intermediary transfer belt 130. In an image forming stations Pc and Pd, cyan and black toner images are formed on photosensitive drums 3c and 3d, and are transferred onto the intermediary transfer belt 130, respectively.

Four color toner images carried on the intermediary transfer belt 130 are fed to a secondary transfer portion T2 and are secondary-transferred all together onto a recording material P there. The recording materials P are supplied from the recording material cassette 10a one by one by a separation roller 6a, and are fed to registration rollers 12. The registration rollers 12 feed the recording material P to the secondary transfer portion T2 in timed relation with the toner image on the intermediary transfer belt 130.

The recording material P carrying the secondary-transferred four color toner images is separated from the intermediary transfer belt 130 by curvature and is fed into a fixing device 9. The fixing device 9 fixes the image on a surface of the recording material P by heating and pressing the recording material P carrying the toner images. Thereafter, the recording material P is discharged to an outside. The image forming apparatus 100 is capable of continuous printing by repeating the process including the sheet feeding, the registration, the image formation, the fixing and the sheet discharge.

As shown in FIG. 1, the image forming stations Pa, Pb, Pc, Pd have substantially the same structures except that developing devices 1a, 1b, 1c and 1d contain different color developers, respectively. Therefore, in the following, the description will be made as to the yellow image forming station Pa, and the like reference numerals with different suffixes are assigned to the elements having the corresponding functions throughout the description.

In the image forming station Pa, around the photosensitive drum 3a, there are provided a charging roller 2a, an exposure device 5a a developing device 1a, a transfer roller 24a and a drum cleaning device 4a. The photosensitive drum 3a comprises an aluminum cylinder and a light semiconductor photosensitive layer on the outer peripheral surface thereof, is rotated at a predetermined process speed in the direction indicated by the arrow. The image forming apparatus 100 can produce 80 A4 size full-color images per minute at the process speed 320 mm/sec.

The charging roller 2a electrically charges the photosensitive drum 3a uniformly to a dark portion potential VD of negative polarity. The exposure device 5a scanningly projects a laser beam ON-OFF modulated scanning line image data provided by expanding yellow separated color image, onto the surface of the photosensitive drum 3a, using a rotational mirror, so that an electrostatic image is formed on the surface of the photosensitive drum 3a. The developing device 1a supplies the toner to the photosensitive drum 3a to develop the electrostatic image into a toner image.

The transfer roller 24a is pressed against the intermediary transfer belt 130 to constitute a toner image transfer portion between the photosensitive drum 3a and the intermediary transfer belt 130. By the application of a DC voltage to the transfer roller 24a, the toner image carried on the photosensitive drum 3a is transferred onto the intermediary transfer belt 130. The drum cleaning device 4a includes a cleaning blade contacted to the photosensitive drum 3a to scrape untransferred toner which has passed through the transfer portion and remaining on the surface of the photosensitive drum 3a, off the surface of the photosensitive drum 3a.

The intermediary transfer belt 130 is stretched around a tension roller 15, an opposing roller 14, and a driving roller 13, and is driven by the driving roller 13 to rotate in the direction indicated by an arrow R2. In the secondary transfer portion T2, a secondary transfer roller 11 is contacted to the intermediary transfer belt 130 supported by the opposing roller 14. By applying a DC voltage to the secondary transfer roller 11, the toner image carried on the intermediary transfer belt 130 is secondary-transferred onto the recording material P fed through the secondary transfer portion T2. A belt cleaning device 19 includes a cleaning web (nonwoven fabric) contacted to the surface of the intermediary transfer belt 130 to remove the toner and/or paper dust.

### <Controller>

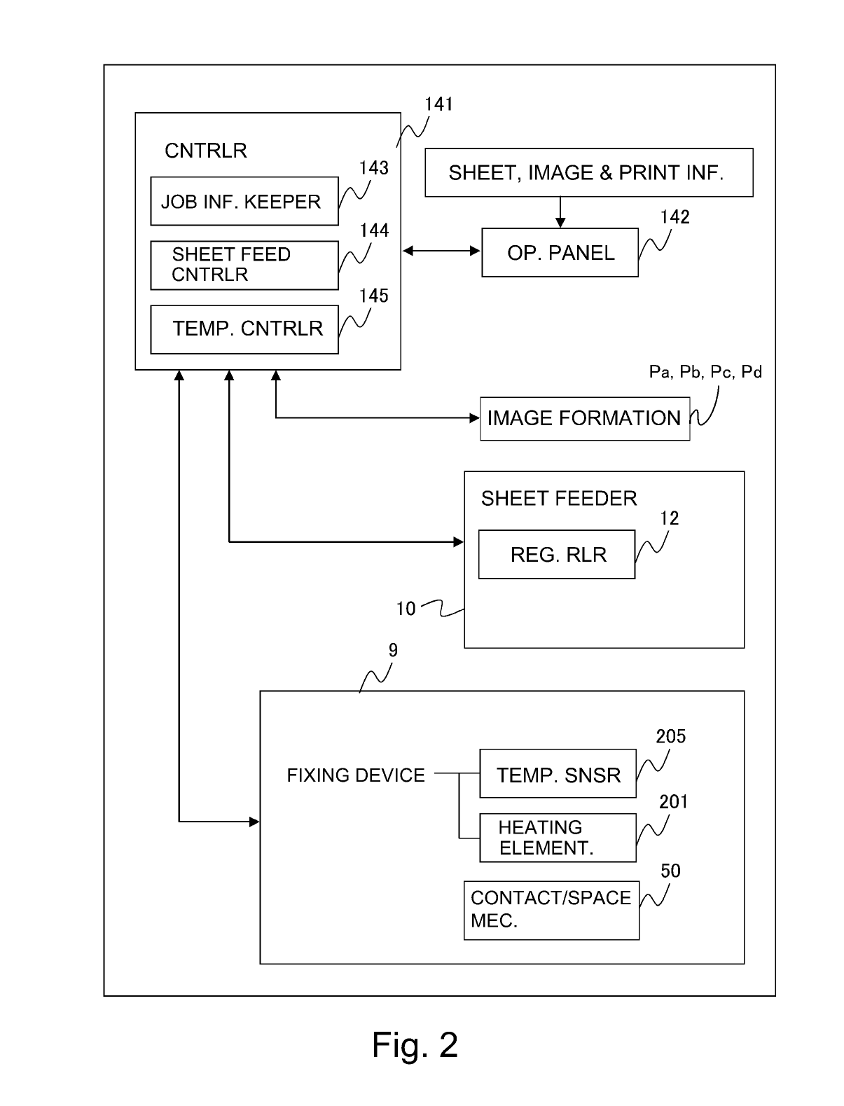

FIG. 2 is a block diagram of a control system for the image forming apparatus. As shown in FIG. 2, a controller 141 as controlling means monitors and controls operation of each unit, and governs the instructions for the respective units so as to effect overall control of the entire operation of the various devices of the image forming apparatus 100.

An operation panel 142 is an interface for the user to access the image forming apparatus 100, and the user can set, through the operation panel 142, image formation job (recording material information such as a basis weight, image information such as a density, print number, and the like).

The image forming apparatus 100 capable of executing a so-called mixed job in which continuously printing is carried out on different kinds (basis weight) recording materials. Recording material cassettes 10a, 10b are capable of feeding plain paper, thin sheet and thick sheet as the recording material into the heating nip N.

By carrying out the mixed job, one complete paperbound book comprising a thick sheet front cover, thin sheet documents and coated paper photographs can be produced. The user can set, on the operation panel 142, details of mixed job such as temperature setting of the fixing device 9 for each recording material.

In addition, such image formation job information can be set for the image forming apparatus 100, from a external personal computer as well as the operation panel 142. The inputted information is temporarily stored in a job information keeping portion 143 which is a part of the controller 141, and is used as control parameters for various operations during the job execution.

### <Feeding Portion>

As shown in FIG. 1, the registration rollers 12 include a rubber roller of ethylene, propylene rubber having a diameter of φ16 mm in the recording material back side, and a metal roller of SUS having a diameter of φ16 mm in the recording material front side, wherein the metal roller is press contacted to the rubber roller by 1 kg load. The rubber roller has an ASKER-C hardness of 40° (1 kg load), and a surface roughness Rz of approx. 20 μm.

The registration rollers 12 temporarily stop the recording material P by a feeding nip formed by the rubber roller and the metal roller to prevent oblique feeding of the recording material, and feed out the recording material P in timed relation with the image formation to assure the proper positioning of the image on the recording material. The controller 141 rotates the rubber roller by operating a stepping motor (unshown) so as to control the feeding and stopping of the recording material when feeding the recording material toward the secondary transfer portion T2.

### <Fixing Device>

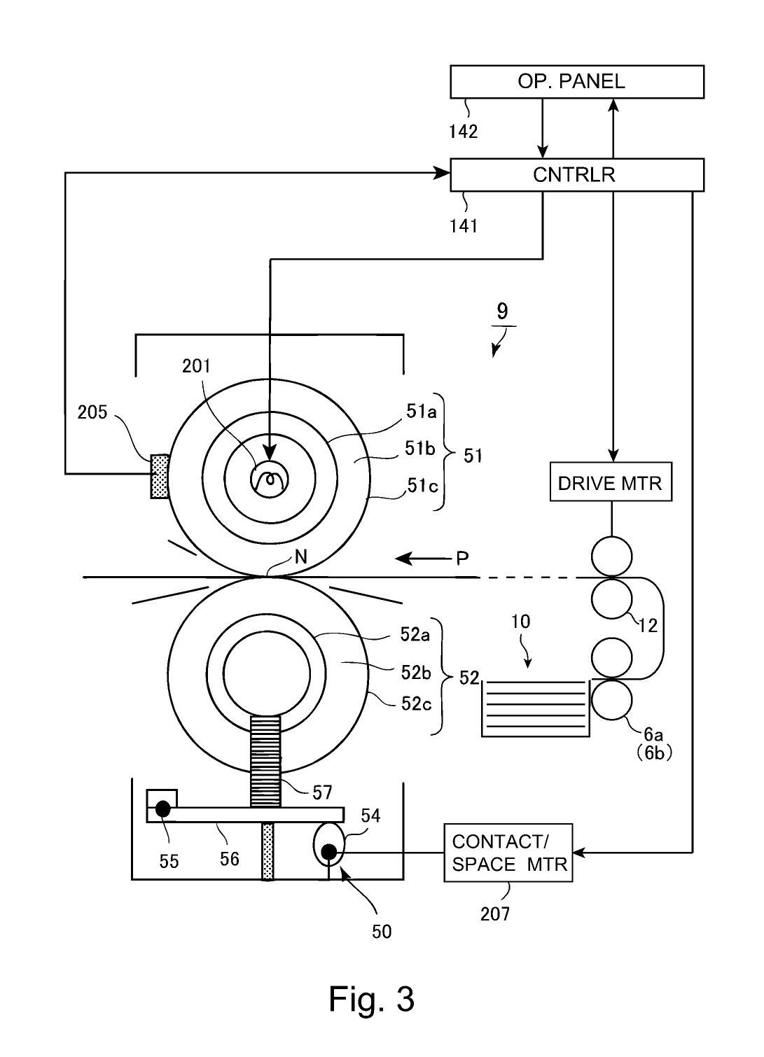

FIG. 3 is an illustration of a structure of the fixing device functioning as fixing means, in a cross-section. As shown in FIG. 3, the recording material P passes through the fixing device 9 in the direction from the right-hand side to the left-hand side in the Figure, and the recording material P is subjected to heat and pressure in the nip N formed between the image surface side fixing roller 51 and a non-image surface side pressing roller 52, by which the toner image fixed on the surface of the recording material P. In the fixing device 9, the heating nip N is formed by press-contacting the pressing roller 52 to the fixing roller 51 functioning as a heating member a temperature of which is controlled at a level not less than a melting point of the toner 1.

The fixing roller 51 comprises a core metal of a mild steel cylindrical material having an outer diameter of φ72 mm, an elastic layer 51b of silicone rubber having a thickness of 4 mm on an outer periphery thereof, a parting layer 51c of a PFA tube having a thickness of 30 μm on a surface of the elastic layer 51b. The pressing roller 52 comprises a core metal of a mild steel cylindrical material having an outer diameter of φ76 mm, an elastic layer 52b of silicone rubber having a thickness of 2 mm on an outer periphery thereof, and a parting layer 52c of PFA tube having a thickness of 30 μm on a surface of the elastic layer 52b.

Inside the fixing roller 51, there is provided a 900 W heating element (halogen heater) 201 functioning as heating means. A temperature sensor (the mister) 205 functioning as detecting means is contacted to a surface of the fixing roller 51 at an exit side of the heating nip N in a center portion with respect to a rotational axis direction.

A temperature control portion 145 controls electric power supply to the heating element 201 on the basis of the output of the temperature sensor 205, so that a surface temperature of the fixing roller 51 detected by the temperature sensor 205 a target temperature which is determined in accordance with the kind (basis weight) of the recording material.

The fixing device 9 includes a moving mechanism 50 for press-contacting and spacing the pressing roller 52 to and from the fixing roller 51. The fixing device 9 waits for the image formation job in the state that the fixing roller 51 and the pressing roller 52 are spaced from each other and that the fixing roller 51 is controlled at a target temperature of a stand-by state.

Opposite end portions of the core metal 51a of the fixing roller 51 are rotatably supported by bearings a height position of which is fixed. Opposite end portions of the core metal 52a of the pressing roller 52 are supported through a pressing spring 57 by a pressing frame 56 which is rotatable about a rotational shaft 55.

When a contacting and spacing motor 207 rotates the pressing cam 54 to raise a rotation end of the pressing frame 56, the pressing roller 52 rises and contacts to the fixing roller 51 by a pressure of the pressing spring 57. When the contacting and spacing motor 207 rotates the pressing cam 54 to lower the rotation end of the pressing frame 56, the pressing roller 52 lowers to space from the fixing roller 51.

The controller 141 controls the contacting and spacing motor 207 to effect the pressing and releasing of the pressing roller 52 to switch between the pressing state and the spaced state relative to the fixing roller 51. A total load in the press-contact state of the pressing roller 52 by the moving mechanism 50 is approx. 60 kgf, and a heating nip N having a length of approx. 10 mm in the feeding direction is formed.

The moving mechanism 50 reduces a thermal load required when the fixing roller 51 is to be heated to a stand-by temperature by the spacing of the pressing roller 52, upon a starting operation, by which the warming-up time is reduced. By the space in the pressing roller 52, the heat is not deprived of the fixing roller 51, and therefore, the warming-up is reduced, and the electric energy consumption of the fixing device 9 is reduced, too. In addition, the moving mechanism 50 spaces the pressing roller 52 when the recording material P is jammed, to facilitate the jam clearance operation by the user.

### Comparison Example

Recently, the image forming apparatus is desired to have a high productivity and to capable forming images on various kinds of recording materials. In the fixing device 9, the nip is expanded in the feeding direction, a thermal conductivity of the heating member is raised, a heating efficiency and/or an electric power efficiency is raised to reduce the energy loss, so that a heat quantity required for continuous toner image fixing on the recording material is assured. In the fixing device 9, the target temperature of the temperature adjustment for the fixing roller 51 is changed depending on whether the recording material is thin sheet or thick sheet or depending on whether the recording material is non-coated paper or coated paper, so that more kinds of the recording material can be used. In the fixing device 9, depending on the kinds of the recording material, an optimum heat quantity is different in terms of an image property (toner offset property, image glossiness or the like) and a feeding performance (sheet creasing, sheet waving, image fixing, sheet separation or the like the, and therefore, the target temperature of the temperature adjustment of the fixing roller 51 is switched depending on the kinds of the recording material. In the fixing device 9, for a recording material falling in a particular group of groups classified depending on the basis weight or surface property of the recording material, the feeding speed through the fixing device is switched to a speed lower than a normal speed in order to increase a cumulated heat quantity supplied by the fixing nip.

However, when such a method is employed to meet various kinds of the recording materials, the productivity at the time when various recording materials mixed. When the so-called mixed job in which different kinds of the recording materials are mixed, the down time at the change of the kind of the recording materials would be a problem. Because it requires time to switch the temperature condition of fixing device and/or the process speed, waiting time is necessitated with the result of overall productivity reduction. According to the embodiments of the present invention, the reduction of the down time resulting from the switching of the kinds of the recording materials in the mixed job in which different kinds of the recording materials are mixed is intended, so that the overall productivity as the image forming apparatus is improved.

### Embodiment 1

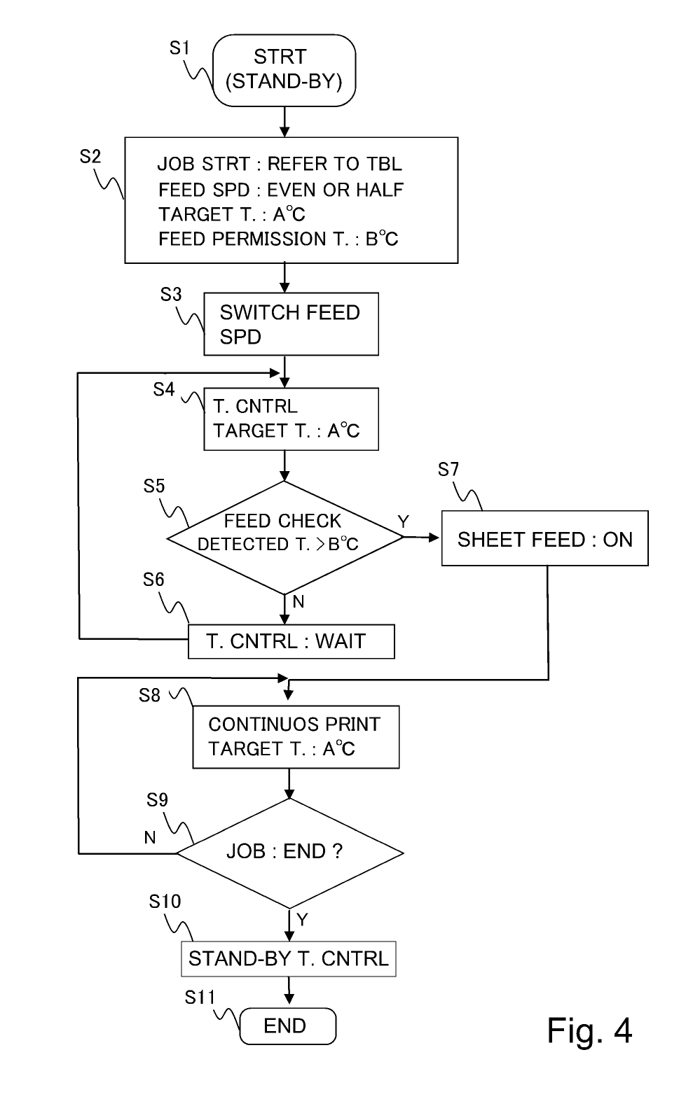

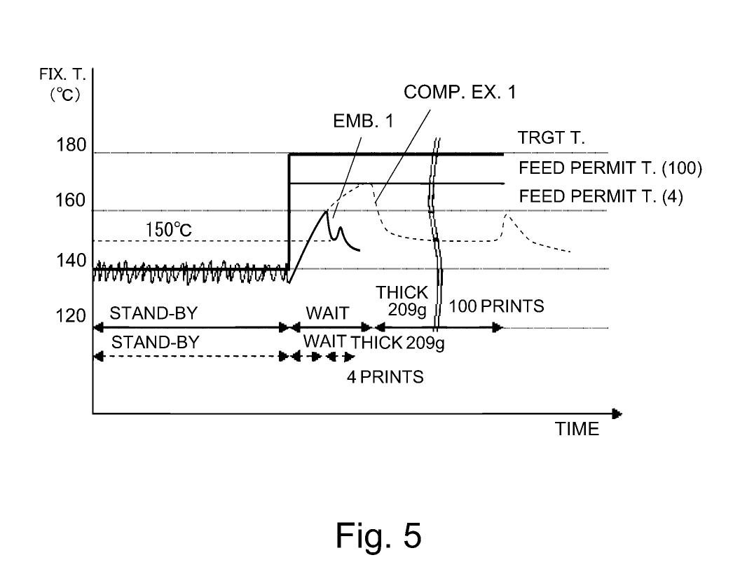

FIG. 4 is a flow chart of a control according Embodiment 1. FIG. 5 is an illustration of a temperature change of the fixing roller at the time when an image formation on a thick sheet is started from a stand-by state.

As shown in FIG. 1, the image forming station Pa includes the photosensitive drum 3a which is an example of the rotatable photosensitive member on which images are formed. A fixing device 9 which is an example of the image heating apparatus includes a fixing roller which is an example of the rotatable image heating member for heating the image formed on the recording material in contact with it.

As shown in FIG. 3, the fixing roller 51 which is an example of the image heating member heats an image surface of the recording material. The pressing roller 52 which is an example of the pressing member is press-contacted to the fixing roller 51 to form a nip for the recording material. The temperature sensor 205 which is an example of the detecting means detects the temperature of the fixing roller 51 to output temperature information. Registration rollers 12 are an example of feeding means feed the recording material to the nip of the fixing device 9 through the secondary transfer portion T2.

The moving mechanism 50 contacts and spaces the fixing roller 51 and the pressing roller 52 relative to each other. The controller 141 is an example of a contacting and spacing controller controls the fixing roller 51 at a second temperature in the state that the pressing roller 52 is spaced by the moving mechanism 50, and press-contacts the pressing roller 52 thereto to form a nip immediately before the feeding of the recording material.

The controller 141 including controlling means, the temperature control portion and the feeding controller, for example controls the sheet feeder 10 on the basis of the temperature information while controlling the fixing roller 51 at the predetermined temperature. When the number of image formations of the image formation job is not less than a predetermined number, the recording material is fed to the nip at the timing when the temperature of the fixing roller 51 rises to the first temperature. When images are formed continuously on a plurality of predetermined recording materials, the start of the image formation is delayed until the temperature of the fixing roller 51 rises to the first temperature in the case that the number of image formations is not less than a predetermined number. However, in the case that the number of image formations is less than a predetermined number, the recording material is fed at the timing when the temperature of the fixing roller 51 rises to a second temperature which is lower than the first temperature.

The above-described image formation start timing onto the photosensitive member 3a is uniquely determined from the paper reaching timing to the fixing nip and the process speed. As for the earliest timing, the image formation is started on the basis of prediction so that the recording material having subjected to the image formation at the timing of the fixing roller 51 reaches the second temperature reaches the fixing nip. As for the second earliest timing, the image formation is started on the basis of prediction so that the toner image is transferred onto the recording material at the timing when the fixing roller 51 reaches the second temperature. As for the timing later than that, the image exposure of the photosensitive drum 3a is started at the timing when the temperature of the fixing roller 51 reaches the second temperature. In the image forming apparatus of this embodiment, when the process speed is 320 mm/sec, the sheet reaches the fixing nip 2.5 sec after the start of the image formation. Therefore, in this embodiment, the image exposure of the photosensitive drum 3a is started 2.5 sec prior to the timing at which the temperature of the fixing roller 51 reaches the second temperature, on the basis of a preset temperature rise curve of the fixing roller 51.

The controller 141 looks up Table 1, on the basis of the information of kind of recording material and the print number temporarily stored in the job information keeping means 143 when receiving the image formation job. By this, the feeding speed, the target temperature of the fixing temperature adjustment and the sheet feeding permission temperature which will be described hereinafter are determined. Table 1 shows the feeding speed, the target temperature of the temperature adjustment and the sheet feeding permission temperature for respective kinds of the recording material, in Embodiment 1.

TABLE 1

| | | | | Sheet feed | |
|---|---|---|---|---|---|
| | | Target temp. | | permission | |
| | | of temp. | Print | Temp. (Deg. C.) | |
| | Feeding | adjustment | No. | Not less | Less |
| | speed | (Deg. C.) | Of Job | than 5 | than 5 |
| Stand-by temp. | 0 | 140 | | Non | Non |
| Thin (52-63) | Even | 130 | | 120 | 110 |
| Plain (64-105) | Even | 150 | | 130 | 120 |
| Thick 1 (106-128) | Even | 160 | | 150 | 130 |
| Thick 2 (129-157) | Even | 170 | | 160 | 150 |
| Thick 3 (158-209) | Even | 180 | | 170 | 160 |
| Thick 4 (210-256) | Half | 160 | | 150 | 140 |

As shown in Table 1, for thin sheets, the target temperature is relatively low in consideration of the separation property from the fixing roller 51, in order to prevent wrapping around (jamming). The thick sheet requires a large thermal load of fixing roller 51, and therefore, the target temperature is relatively higher in order to assure the fixing power for the toner image. In the setting in each range of the recording materials, the supplied heat quantity is large if the thermal capacity is large, in order to satisfy both of the image property (fixing offset property and image glossiness) and feeding performance (crease, separation property). In the case of thick sheet 4, the thermal capacity of the recording material is the largest, and therefore, the recording material feeding speed in the nip is one half of the normal speed.
(1) the target temperature for the thin sheet (52-63 g/m2) is 130 degree C., and the process speed is 320 mm/sec.
(2) the target temperature for the plain paper (64-105 g/m2) is 150 degree C., and the process speed is 320 mm/sec.
(3) the target temperature for the thick sheet 1 (106-128 g/m2) is 160 degree C., and the process speed is 320 mm/sec.
(4) the target temperature for the thick sheet 2 (129-157 g/m2) is 170 degree C., and the process speed is 320 mm/sec.
(5) the target temperature for the thick sheet 1 (158-209 g/m2) is 180 degree C., and the process speed is 320 mm/sec.
(6) the target temperature for the thick sheet 4 (210-256 g/m2) is 160 degree C., and the process speed is 160 mm/sec.

The fixing roller 51 of the image forming apparatus 100 is made of a material having a relatively large thermal capacity, and therefore, the initial warming-up time is long. In view of this, in order that the target temperature of temperature adjustment is quickly reached upon reception of the printing signal, it is preferable to effect the control for the stand-by temperature adjustment even when the normal printing operation is not carried out. As for the target temperature of the stand-by temperature adjustment, the initial setting thereof is 140 degree C. so that the highest speed print is carried out with the thin sheet (52-63 g/m2) and plain paper (64-105 g/m2). By the initial setting of 140 degree C. for the stand-by temperature of the fixing roller 51, no waiting time occurs for the plain paper which is post frequently used, so that the image formation can be carried out instantaneously. As for the stand-by temperature, the target temperature of the temperature adjustment can be changed in the operating portion 142. If the user frequently uses thick sheets, the temperature can be changed to 150° C., 160° C., 170° C. or the like.

The sheet feeding permission temperature is a temperature (trigger) of the fixing roller 51 at which the image formation starts by operating the sheet feeder 10 after the target temperature of the temperature adjustment is switched as described in the foregoing, simultaneously with the production of the start signal of the job by the controller 141. The sheet feeding operation control portion 144 in the controller 141 operates the sheet feeder 10 when the detected temperature of the fixing roller 51 by the temperature sensor 205 exceeds the sheet feeding permission temperature.

The controller 141 is provided with a plurality of tables so that the sheet feeding permission temperature can be selected depending on the print number (A4 conversion value) of the job. In Embodiment 1, two tables are prepared for the case of not less than five sheet (A4 conversion value) prints and in the case of less than five sheet (A4 conversion value) prints, respectively. This is because if the number of prints is less than five, even if the temperature of the fixing roller 51 at the time of the start of the sheet passing is low, the printing job will be completed before the temperature drop after the start falls in the range out of the tolerable range.
(1) for thin sheet, the sheet feeding permission temperature is lowered from 120 degree C. to 110 degree C.
(2) for the plain paper, the sheet feeding permission temperature is lowered from 140 degree C. to 130 degree C.
(3) for thick sheet 1, the sheet feeding permission temperature is lowered from 150 degree C. to 140 degree C.
(4) for thick sheet 2, the sheet feeding permission temperature is lowered from 160 degree C. to 150 degree C.
(5) for thick sheet 3, the sheet feeding permission temperature is lowered from 170 degree C. to 160 degree C.
(6) for thick sheet 4, the sheet feeding permission temperature is lowered from 150 degree C. to 140 degree C.

Referring to FIG. 3 and FIG. 4, the controller 141 starts preparation for the image formation when the controller 141 receives execution instructions of the image formation job during the stand-by state (S1). Here, it is assumed for example that the controller 141 receives an image formation job of 100 prints on one side of A4 size thick sheets 3 (158-209 g/m2) (S1).

The controller 141 looks up Table 1 and determines the job feeding speed, the target temperature A degree C. of the fixing temperature adjustment and the sheet feeding permission temperature B degree C. on the basis of the recording material information and the print number information kept in the job information keeping portion 143 (S2). More particularly, the controller 141 determines, from Table 1, that the feeding speed is the same, the target temperature of temperature adjustment of the fixing roller 51 is 180 degree C., and the sheet feeding permission temperature is 170 degree C. (S2).

The controller 141 starts various means (image forming station, fixing device or the like) in the device at predetermined feeding speeds.

The fixing temperature controller 145 of the controller 141 controls heating element 201 on the basis of the temperature information supplied from the temperature sensor 205 to start temperature raising of the fixing roller 51. The heating element 201 is operated from the stand-by temperature control 140 degree C. toward the target temperature 180 degree C. of the temperature adjustment for the thick sheet 3. By this, the temperature of the fixing roller 51 starts rising.

The controller 141 effects a sheet feeding discrimination of the recording material P (thick sheet 3) relative to a current temperature of the fixing roller 51. Since the sheet feeding permission temperature is 170 degree C., the image formation is awaited until the detected temperature of the fixing roller 51 by the temperature sensor 205 exceeds 170 degree C. When the fixing roller 51 is heated, and the temperature thereof rises (S4-S6) up to 171 degree C.>sheet feeding permission temperature 170 degree C., the controller 141 produces a sheet feeding operation signal to the sheet feeder 10 (S7).

Thereafter, the controller 141 sets the target temperature of the temperature adjustment at 180 degree C., and executes the continuous print operation.

When the controller 141 discriminates completion of the job (S9, Y), the controller 141 returns the target temperature of the temperature adjustment to the stand-by temperature (S10), and a series of operations is finished.

FIG. 5 show a temperature change of the surface of the fixing roller 51 in the operation according to the operation flow of Embodiment 1. The fixing device 9 requires the surface temperature of the fixing roller 51 not less than 150 degree C. in order to stably fix the toner image carried on the recording material which is thick sheet 3. With continuous sheet processing, the surface temperature of the fixing roller 51 lowers to a level at which the electric power demand-supply balance is reached.

As shown in FIG. 5 by a solid line, when an image formation job of 100 A4 size prints on the thick sheet 3 from the stand-by state is executed, the start of the image forming operation is awaited until the detected temperature of the fixing roller 51 exceeds the sheet feeding permission temperature 170 degree C. When the number of the prints of the image formation job is large, a long waiting time for the temperature adjustment is required in order to make the surface temperature of the fixing roller 51 at the job start relatively higher. After start of the image formation, the fixing roller 51 is deprived of heat by the recording material of the thick sheet 3 to reach a balanced state at the surface temperature 150 degree C. of the fixing roller 51, and the image formation job is completed without falling to a level less than 150 degree C. required for the heat fixing of the toner image.

Referring to FIG. 3 and FIG. 4, when a job of prints on one sides of four A4 size thick sheets 3 is received in the stand-by state, the image formation is started (S7) before the detected temperature of the fixing roller 51 by the temperature sensor 205 reaches 170 degree C. Referring to table 1, the controller 141 determines that the sheet feeding permission temperature is 160 degree C. (S2) because the job is four A4 size prints. Therefore, the waiting time (S4-S6) required for the temperature adjustment up to the positive sheet feeding discrimination (S5, Y).

As shown in FIG. 5 by a solid line, when the image formation job of four prints on A4 size thick sheets 3 is executed in the stand-by state in Embodiment 1, the image forming operation is started at the time when the detected temperature of the fixing roller 51 reaches 160 degree C., which is prior to the sheet feeding permission temperature of 170 degree C. When the print number of the image formation job is small, the temperature drop of the fixing roller 51 is small, and correspondingly it is unnecessary to await until the temperature is very high when the job operation starts. Later start of the image forming operation, surface temperature of the fixing roller 51 lowers by the recording material of the thick sheet 3 taking the heat away, but the image formation job is completed before the temperature falls down to a level lower than 150 degree C. required to heat fix the toner image. Therefore, as compared with the case in which the image forming operation is awaited until the temperature reaches the sheet feeding permission temperature of 170 degree C. (broken line) in comparison example 1, the time from the reception of the image formation job to the completion of the image formation is reduced.

According to the control of Embodiment 1, the sheet feeding permission temperature is changed to a optimum level in accordance with the already obtained print number information of the job, by which the temperature control waiting time can be reduced. For the execution of the image formation job, the optimum sheet feeding permission temperature is determined on the basis of the kind of the recording material and the job print number information, by which the necessary and minimum temperature control waiting time may be used. By executing the job the appropriate switching control corresponding to the recording material information and the job print number information, the down time necessary for which the media switching can be minimized. By this, the down time upon media (recording material) change can be minimized.

### Embodiment 2

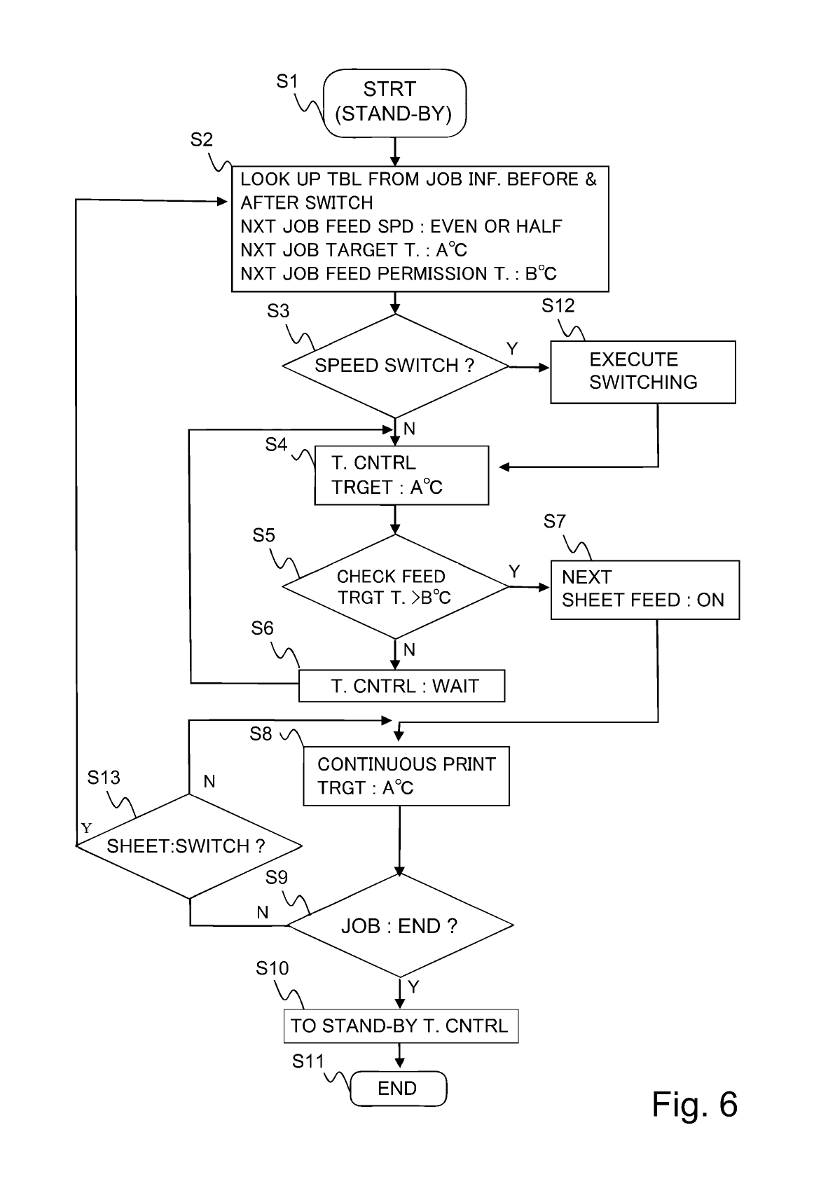

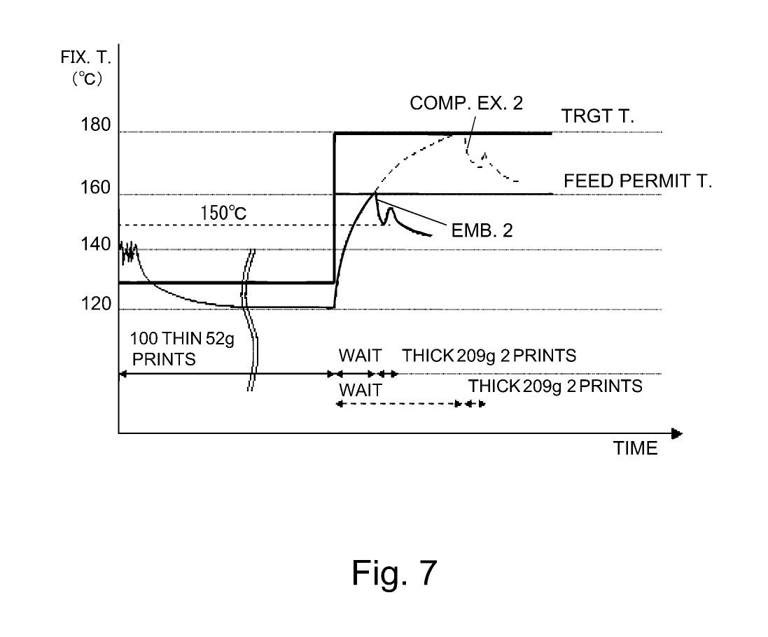

FIG. 6 is a flow chart of a control according Embodiment 2. FIG. 7 is an illustration of a temperature change of a fixing roller at the time when the recording material changes from the thin sheet to the thick sheet. In Embodiment 1, in one image formation job starting in the stand-by state, an optimum temperature control stand-by time is determined on the basis of the kind of recording material when the print number. In Embodiment 2, when the recording material is changed in the process of a continuous image formation, the optimum waiting time of the temperature adjustment is determined. In Embodiment 2, a so-called mixed job in which a job including different kinds of recording material is continuously processed, as in the case of continuous printing on a thick sheet for a cover and thin content sheets of a paperbound book,

As shown in FIG. 3, the controller 141 can control the heating of the thin sheets which are an example of recording materials of a first kind, and then the heating of the thick sheet 3 which is an example of a second kind recording material for which the temperature of the fixing roller 51 is made higher than that for the thin sheets. The controller 141 controls the sheet feeder 10 on the basis of the temperature information. When the heating number on the thick sheets 3 is not less than a predetermined number, the controller 141 feeds the recording material into the nip at the timing when the temperature of the fixing roller 51 reaches the first temperature. When the heating number on the thick sheets 3 is less than the predetermined number, the controller 141 feeds the recording material into the nip at the timing when the temperature of the fixing roller 51 reaches the second temperature which is lower than the first temperature.

Table 2 is a media table of the feeding speed, the target temperature of the temperature adjustment and the sheet feeding permission temperature in Embodiment 2.

TABLE 2

| | | | | Sheet feed | |
|---|---|---|---|---|---|
| | | | | permission | |
| | | | Temp. | Temp. (Deg. C.) | |
| | | Target temp. | Diff. | ≧3 | <3 |
| | | of temp. | Deg. C. | sheets | sheets |
| | Feeding | adjustment | ≧30 | ≧5 | <5 |
| | speed | (Deg. C.) | <30 | sheets | sheets |
| Stand-by temp. | 0 | 140 | | Non | Non |
| Thin (52-63) | Even | 130 | | 120 | 110 |
| Plain (64-105) | Even | 150 | | 130 | 120 |
| Thick 1 (106-128) | Even | 160 | | 150 | 130 |
| Thick 2 (129-157) | Even | 170 | | 160 | 150 |
| Thick 3 (158-209) | Even | 180 | | 170 | 160 |
| Thick 4 (210-256) | Half | 160 | | 150 | 140 |

As shown in 2, the feeding speed of the recording material and the target temperature of the temperature adjustment are the same as those of Table 1 of Embodiment 1. However, the sheet feeding permission temperature is set taken into account a target temperature difference of the temperature adjustment between the jobs before and after the switching of the recording material as well as the print number of the subsequent job as in Embodiment 1.

For example, the switching is from thick sheet 1 (160 degree C.) to thick sheet 3 (180 degree C.) in a mixed job, the sheet feeding permission temperature is determined depending on whether or not the job number of thick sheets 3 is not less than or less than five sheet (A4 conversion value), since the target temperature difference is A20 degree C. (less than A30 degree C.). However, when the switching is from thin sheet (130 degree C.) to thick sheet 3 (180 degree C.), the sheet feeding permission temperature is determined depending on whether or not the job print number of thick sheets 3 is not less than or less than three (A4 conversion value the, since the target temperature difference of the temperature adjustment is A50 degree C. (not less than A30 degree C.).

This is because even if the kind of recording material in the subsequent job remains the same, an inside heat accumulation state of the fixing roller 51 is different depending on the target temperature of the temperature adjustment in the prior job, and therefore, the change of the surface temperature of the fixing roller 51 after the start of the image formation in the subsequent continuous printing job is different. The accumulation heat quantity inside the fixing roller 51 increases with decrease of the target temperature difference between the prior job and the subsequent job, and therefore, when the target temperature difference is small, a temperature drop speed after the start of the image formation of the subsequent job is slow, a relatively large number of prints can be produced by the time when the temperature lowers beyond the temperature required for the heat fixing of the toner image. When the target temperature difference less than 30 degree C., the temperature 150 degree C. can be maintained until four sheet fixing operations after the start of the image formation, but when the target temperature difference is not less than 30 degree C., the temperature 150 degree C. is likely to be maintained until only two sheet fixing operation's after the start of the image formation. Therefore, the sheet feeding permission temperature table 2 is prepared.

Referring to FIG. 3 and FIG. 6, the controller 141 executes a mixed job including 100 continuous image formations on A4 size thin sheet and subsequent two continuous image formations on A4 size thick sheet 3 (recording material is switched). The controller 141 receives the recording material switching instructions to the thick sheet 3 during the preceding continuous image formations (on the thin sheet) in the mixed job (S1). When the controller 141 receives the recording material switching instructions (S1), the controller 141 determines the feeding speed of the subsequent job, the target temperature A degree C. of the temperature adjustment and the sheet feeding permission temperature B degree C. on the basis of recording material information before and after the switching and subsequent job print number information, referring to Table 2 (S2).

Here, the target temperature difference of the temperature adjustment between before and after the switching is 180 degree C.-130 degree C=50 degree C., which is not less than Δ30 degree C., and the print number of the subsequent job is two. Therefore, the controller 141 referring to Table 2 determines that the feeding speed of the subsequent job is the same, that the target temperature of the temperature adjustment is 180 degree C., and that the sheet feeding permission temperature is 160 degree C.

Subsequent control operations (S3-S10) are similar to those of Embodiment 1, and the sheet feeding operation and the printing operation for the subsequent job are executed after necessary and minimum waiting time for the temperature adjustment. When the controller 141 receives further recording material switching job during the sheet feeding operation and printing operation of the subsequent job (S13), the above-described settings and waiting are carried out for the further subsequent job (S2), and the current subsequent job is carried out (S3-S10).

FIG. 7 shows a temperature change of a surface of the fixing roller 51 when the mixed job is executed in accordance with the operation flow of Embodiment 2. As shown in FIG. 7 by the solid line, according to the control of Embodiment 2, the sheet processing of thick sheet 3 is started at 160 degree C. timing which is prior to stipulated 180 degree C. timing, 7 sec after the switching of the target temperature. The temperature of the fixing roller 51 decreases due to the processing on the thick sheet 3, but since the print number is small, the printings on the thick sheets 3 are already completed before the surface temperature of the fixing roller 51 lowers beyond 150 degree C. After the completion, the surface temperature of the fixing roller 51 rises, and thereafter, the heating of the fixing roller 51 is stopped, and the temperature drops.

On the contrary, in the case that the image formation on the thick sheet 3 is started after waiting for the temperature rise to the stipulated 180 degree C. as indicated by a broken line in FIG. 7 (comparison example 2), the waiting time is 20 sec. Therefore, with the control of Embodiment 2, the image formation on the thick sheet 3 is executed after less than half waiting time as compared with the comparison example indicated by the broken line. That is, the waiting time for the temperature adjustment at the time when the recording material is switched from the thin sheet to the thick sheet 3 is reduced from 20 sec to 7 sec.

In the control of Embodiment 2 in the mixed job including the recording materials for which the target temperatures of the temperature adjustment are different, the optimum sheet feeding permission temperature is determined on the basis of the difference of the kind of recording materials between before and after the switching and the print number information after the switching. By this, the stand-by time of the temperature adjustment is optimum, and the total productivity of the image forming apparatus 100 is enhanced.

The control of Embodiment 2 improves a media mixed productivity, that is, minimizes the down time at the time of switching of the recording material. By executing an appropriate job switching control in accordance with the recording material information and the job print number of information, the down time at the time of switching of recording material in the mixed job can be minimized.

### Embodiment 3

In Embodiments 1 and 2, if the number of the image formations requiring to raise the target temperature of the temperature control is less than 5 (3), the target temperature of the temperature adjustment of the fixing roller is set evenly. In Embodiment 3, for less than five sheets, the target temperature of the temperature adjustment of the fixing roller is decreased with the decrease of the number of the image formations, so that the waiting time is further reduced.

The controller 141 which is an example of the feeding speed controller or the controlling means controls the sheet feeder 10 on the basis of the temperature information. When a heating number on thick sheets 3 which is an example of a second kind recording material is less than a predetermined number, a second temperature is lower if the heating number is smaller. If it is not less than the predetermined number, the recording material is fed into the nip at the timing of the reaching of the temperature of the fixing roller 51 up to the first temperature which is higher than any of the second temperatures, evenly.

The first temperature is so selected that the temperature of the fixing roller at the time when the heating of the fixing roller 51 and the cooling by the recording material are balanced with each other in the continuous image forming operation to provide a constant temperature of the fixing roller is a lower limit value of the temperature necessary for the fixing of the toner image on the recording material. The second temperature is so selected that when the number of image formations exceeding such a number, the temperature may lower beyond the lower limit value of the temperature necessary for the fixing of the toner image on the recording material.

### Embodiment 4

In Embodiments 1 and 2, it is intended to reduce the waiting time of the image formation attributable to the change of the target temperature of the temperature adjustment for the fixing roller. In Embodiment 4, it is intended to reduce the waiting time of the image formation attributable to switching of the image forming speed.

The controller 141 sets the operation speeds of the image forming means and the image heating apparatus which are examples of the image forming speed to a first image forming speed and a first image heating speed, respectively, when the recording material is the first kind recording material. The controller 141 effects the control such that the operation speeds of the image forming means and the image heating apparatus are a second image forming speed and a second image heating speed which are slower than the first image forming speed and the first image heating speed, respectively, when the recording material is a second kind recording material.

The controller 141 continuously forms images on a plurality of the first kind recording materials, and then, continuously forms images on a plurality of second kind recording materials. At this time, when the number of the second kind recording materials is not less than a predetermined number, the operation speeds of the image forming means and the image heating apparatus are decreased to the second image forming speed and the second image heating speed, respectively. However, when the number of the second kind recording materials is less than the predetermined number, the operation speeds of the image forming means and the image heating apparatus are maintained at the first image forming speed and the first image heating speed, respectively.

The image forming speed is the operation speed of the photosensitive member 3 and an intermediary transfer belt 130, and the process speed is a speed of the recording material P passing through the fixing device 9, which is the fixing speed. In this embodiment, the process speed and the fixing speed are the same. In addition, in this embodiment, the peripheral speeds of the photosensitive member 3a and the intermediary transfer belt 130 are the same.

The present invention is applicable to a case where the peripheral speeds of the photosensitive member 3a and the intermediary transfer belt 130 are slightly different. In this case, it can be deemed that peripheral speeds are the same. Therefore, the changing of the operation speed of image forming means that the peripheral speeds of the photosensitive member and the intermediary transfer belt which are slightly different from each other changes to different speeds which are slightly different from each other.

Even if the process speed and the fixing speed are slightly different from each other, the present invention is applicable. For example, depending on a section structure of the image forming apparatus, a loop of the recording material P is formed between the secondary transfer portion and the fixing device during the feeding of the recording material. More specifically, the fixing speed is set to be slower by approximately 1-3% than the process speed. The feeding speed in the description of this embodiment means either one of these speeds, and the present invention is applicable irrespective of whether or not there is a speed difference.

As shown in FIG. 3, when the heating number of thick sheets 4 which are in the example of the second kind recording material is not less than a predetermined number, the controller 141 lowers the rotational speed of the fixing roller 51 and then feeds the recording material into the nip. When the heating number of the thick sheets 4 is less than the predetermined number, the controller feeds the recording material into the nip without changing the rotational speed of the fixing roller 51.

Table 3 is a media table of the feeding speed, the target temperature of the temperature adjustment and the sheet feeding permission temperature in Embodiment 4

TABLE 3

| | | | | Sheet feed | | Sheet feed | |
|---|---|---|---|---|---|---|---|
| | | | | permission | | speed | |
| | | | Temp. | Temp. (Deg. C.) | | switching | |
| | | Target temp. | Diff. | ≧3 | <3 | ≧3 | <3 |
| | | of temp. | Deg. C. | sheets | sheets | sheets | sheets |
| | Feed | adjustment | ≧30 | ≧5 | <5 | ≧5 | <5 |
| | speed | (Deg. C.) | <30 | sheets | sheets | sheets | sheets |
| Stand-by T . . . | 0 | 140 | | Non | Non | Non | Non |
| Thin (52-63) | Even | 130 | | 120 | 110 | Non | Non |
| Plain (64-105) | Even | 150 | | 130 | 120 | Non | Non |
| Thick 1 (106-128) | Even | 160 | | 150 | 130 | Non | Non |
| Thick 2 (129-157) | Even | 170 | | 160 | 150 | Non | Non |
| Thick 3 (158-209) | Even | 180 | | 170 | 160 | Non | Non |
| Thick 4 (210-256) | Half | 160 | | 150 | 140 | Yes | Non |

As shown in Table 3, the settings of the feeding speed, the target temperature of the temperature adjustment and the sheet feeding permission temperature are fundamentally similar to those of Table 2 of Embodiment 2. However, in Embodiment 3, it is determined on the basis of the print number of a subsequent job of the thick sheet 4 whether to execute the switching over the feeding speed for the subsequent job.

As shown in FIG. 3, a mixed job will be taken for example, in which the recording material is continuously switched from A4 size thick sheet 1 (160 degree C., 320 mm/sec) to thick sheet 4 (160 degree C., 160 mm/sec). In this case, the target temperature difference of the temperature adjustment is AO degree C., and therefore, when the print number on the thick sheets 4 is not less than five (A4 size conversion), the controller 141 waits for completion of all the image formations of the prior job and then switches the feeding speed of the intermediary transfer belt (130 in FIG. 1) and the like from the same speed to the half-speed. When the print number is large, the temperature drop of the fixing roller 51 in the continuous image formation on the thick sheets 4 which absorbs large quantity of heat, and therefore, in order to increase the supplied heat quantity per one sheet, it is necessary to lower the feeding speed.

However, when the print number on the thick sheets 4 is less than five, the controller 141 executes the subsequent job on the thick sheets 4 without changing the feeding speed. This is because even when the thick sheet 4 which absorbs a large quantity of heat is processed, if the number is small, the subsequent job will be completed before the surface temperature of the fixing roller 51 lowers too much, without changing the feeding speed. For the same reasons as with Embodiments 1 and 2, the waiting time can be reduced for the switching of the feeding speed as well as for the temperature adjustment.

Referring to FIG. 3 and FIG. 6, the controller 141 discriminates whether to execute the switching of the feeding speed, at the time when the kind of recording material is switched in the mixed job (S2). When the controller 141 discriminates the switching to be executed (Y of S3), the switching of the feeding speed is executed (S12).

The switching operation of the feeding speed has to be carried out at every portions (image forming stations Pa, Pb, Pc, Pd, the fixing device 9, the feeding portion 7 and the sheet feeder 10) in the image forming apparatus 100, and in addition, it can be carried out only after the completion of the prior job. For this reason, it requires long time with the result of long down time of the image forming apparatus 100.

However, in Embodiment 3, the controller 141 does not switch the feeding speed (N of S3) if not necessary, and proceeds to the temperature control (S4) to start the subsequent job without changing the feeding speed, and therefore, the time required for switching the feeding speed can be saved.

The effect of the control of Embodiment 3 has been checked. A mixed job has been executed in an image forming apparatus 100, in which the operation is switched from the continuous 100 image formations on A4 size thick sheet 1 to two continuous image formations on the A4 size thick sheets 4. Without using Embodiment 3, the switching of the feeding speed at the time when the recording material is switched requires approx. 15 sec.

By the image formation without changing the feeding speed when the number of the A4 size conversion sheets is less than five, the mixed job has been carried out without problem. No significant difference is recognized between this case and in the case in which the feeding speed is switched unconditionally, in the image quality (fixing property, glossiness property and quality) of the small number of sheets. In the mixed job, if the print number of the subsequent job it small, an optimum feeding permission temperature (a temperature at which the feeding of the recording material from the recording material cassette starts) or the feeding speed is selected on the basis of recording material information before and after the switching of the recording material, by which the media switching time can be minimized. According to the control of Embodiment 4, the productivity of the image forming apparatus 100 can be improved.

In the foregoing, Embodiments 1-4 has been described in detail, but the present invention is not limited to these embodiments, and the following examples are applicable.

For example, the heating member and the pressing member may be belt members or roller members. At least one of the heating member and the pressing member may be a seamless belt. A fixing device comprises a detachably mountable nip constituted by a heating member in the form of a seamless belt and a contacting and spacing mechanism.

The heating type of the fixing member is not limited to the halogen lamp heater but may use another type such as induction heating or the like.

The image formation system of the image forming apparatus may be a type in which a color image this form of using a single photosensitive member, or a type in which images a transfer from photosensitive members while attracting and carrying the recording material on a recording material feeding belt.

In the foregoing embodiments, a printer has been taken as examples, the present invention is applicable to various uses including a copying machine, a facsimile machine and a complex machine having a plurality of such functions.

### INDUSTRIAL APPLICABILITY

According to the present invention, an image forming apparatus which can properly carry out of the image forming operation with minimized waiting time.

1. An image forming apparatus comprising:
image forming means for forming an image on a recording material;
fixing means for fixing an image formed on a recording material;
detecting means for detecting a temperature of said fixing means; and
controlling means for controlling an image formation start timing in accordance with an output of said detecting means, wherein in an operation of continuously forming images on a plurality of predetermined recording materials, when a number of image formations is not less than a predetermined number, start of the image formation is delayed until a temperature of said fixing means rises up to a first temperature, and when the number of image formations is less than the predetermined number, the image formation is started when the temperature of said fixing means rises up to a second temperature which is lower than the first temperature.

2. An apparatus according to claim 1, wherein when the images are continuously formed on the plurality of predetermined recording materials and the number of image formations is less than the predetermined number, the second temperature is lower when the number of image formations is smaller.

3. An apparatus according to claim 1, wherein said fixing means includes a heating member for heating the image formed on the recording material in contact therewith, and said controlling means controls the image formation start timing in accordance with the temperature of the heating member detected by said detecting means.

4. An apparatus according to claim 1, wherein said image forming means includes a photosensitive member on which an image is formed, and said controlling means controls image formation start timing on said photosensitive member in accordance with the output of said detecting means.

5. An image forming apparatus comprising:
image forming means for forming an image on a recording material;
fixing means for fixing an image formed on a recording material;
detecting means for detecting a temperature of said fixing means; and
controlling means for controlling an image formation start timing in accordance with an output of said detecting means, wherein in an operation of continuously forming images on a plurality of predetermined recording materials, when a number of image formations is not less than a predetermined number, start of the image formation is delayed until a temperature of said fixing means rises up to a target temperature predetermined on the basis of a kind of the recording material, and when the number of image formations is less than the predetermined number, the image formation is started when the temperature of said fixing means rises up to a predetermined temperature which is lower than the target temperature.

6. An apparatus according to claim 5, wherein when the images are continuously formed on the plurality of predetermined recording materials and the number of image formations is less than the predetermined number, the predetermined temperature is lower when the number of image formations is smaller.

7. An apparatus according to claim 5, wherein said fixing means includes a heating member for heating the image formed on the recording material in contact therewith, and said controlling means controls the image formation start timing in accordance with the temperature of the heating member detected by said detecting means.

8. An apparatus according to claim 5, wherein said image forming means includes a photosensitive member on which an image is formed, and said controlling means controls image formation start timing on said photosensitive member in accordance with the output of said detecting means.

9. An image forming apparatus comprising:
image forming means for forming an image on a recording material;
fixing means for fixing an image formed on a recording material; and
controlling means for controlling an image formation start timing, wherein in an operation of continuously forming images on a plurality of predetermined recording materials, when a number of image formations is not less than a predetermined number, operation speeds of said image forming means and said fixing means are controlled in accordance with a kind of recording material, and when the number of image formations is less than the predetermined number, the operation speeds of said image forming means and said fixing means is controlled at speeds higher than the operation speeds determined in accordance with the kind of the recording material.

10. An apparatus according to claim 9, wherein said image forming means includes a rotatable photosensitive member on which an image is formed, and said fixing means includes a rotatable heating member for heating an image formed on the recording material in contact therewith, wherein said controlling means controls a peripheral speed of said photosensitive member as the operation speed of said image forming means, and controls a peripheral speed of said heating member as the operation speed of said fixing means.

11. An apparatus according to claim 9, wherein when the image formation is executed on the recording material having a basis weight less than a predetermined basis weight, said controlling means controls the operation speeds of said image forming means and said fixing means at a first image forming speed and a first fixing speed, respectively, and when the image formation is executed on the recording material having a basis weight less than the predetermined basis weight, said controlling means controls the operation speeds of said image forming means and said fixing means at a second image forming speed and a second fixing speed which are slower than the first image forming speed and the first fixing speed, respectively.

12. An image forming apparatus comprising:
image forming means for forming an image on a recording material;
fixing means for fixing an image formed on a recording material;
detecting means for detecting a temperature of said fixing means;
first controlling means for controlling a target temperature of said fixing means in accordance with a basis weight of recording material; and
second controlling means for starting image formation, wherein images are formed continuously on a plurality of recording materials having a first basis weight in a state that a temperature of said fixing means is controlled at a first target temperature predetermined in accordance with the basis weight of the recording material, and then successively, images are formed continuously on a plurality of recording materials having a second basis weight which is larger than the first basis weight, start of image formation is awaited until the temperature of said fixing means rises up to a second target temperature predetermined in accordance with the basis weight of the recording material if the number of image formations is not less than a predetermined number, and the image formation is started when the temperature of said fixing means rises up to a predetermined temperature lower than the second target temperature, when the number of image formations is less than the predetermined number.

13. An apparatus according to claim 12, wherein when the number of image formations on a second kind is less than the predetermined number, said second controlling means changes the predetermined temperature which is lower when the number of image formations is smaller.

14. An apparatus according to claim 12, wherein said fixing means includes a heating member for heating the image formed on the recording material in contact therewith, and said second controlling means controls image formation start timing in accordance with the temperature of said fixing member detected by said detecting means.

15. An apparatus according to claim 12, wherein said image forming means includes a photosensitive member on which the images are formed, and said second controlling means controls the image formation start timing on said photosensitive member in accordance with an output of said detecting means.

16. An image forming apparatus comprising:
image forming means for forming an image on a recording material;
fixing means for heating an image formed on a recording material;
first controlling means for controlling operation speeds of said image forming means and said fixing means in accordance with a basis weight of the recording material; and
second controlling means for starting image formation, wherein when images are formed continuously on a plurality of recording materials having a first basis weight in a state that operation speeds of said image forming means and said fixing means are a first image forming speed and a first fixing speed, respectively, and then successively, images are formed continuously on a plurality of the recording materials having a second basis weight which is larger than the first basis weight, said second controlling means starts the image formation after decreasing the operation speeds of said image forming means and said fixing means to the second image forming speed and the second fixing speed which are slower than the first image forming speed and the first fixing speed, respectively, if the number of image formations is not less than the predetermined number, and said second controlling means starts the image formation while maintaining the operation speeds of said image forming means and said fixing means at the first image forming speed and the first fixing speed, respectively, if the number of image formations is less than the predetermined number.

17. An apparatus according to claim 16, wherein said image forming means includes a rotatable photosensitive member on which an image is formed, and said fixing means includes a rotatable heating member for heating an image formed on the recording material in contact therewith, wherein said controlling means controls a peripheral speed of said photosensitive member as the operation speed of said image forming means, and controls a peripheral speed of said heating member as the operation speed the fixing means.

18. An apparatus according to claim 16, wherein said second controlling means controls the image formation start timing on said photosensitive member.
